(19) United States
(12) Patent Application Publication
(10) Pub. No.: US 2022/0338669 A1
(43) Pub. Date: Oct. 27, 2022

(54) BEVERAGE MACHINE WITH AUTOMATED BREW PARAMETER ADJUSTMENT

(71) Applicant: Keurig Green Mountain, Inc., Burlington, MA (US)

(72) Inventors: Jeffrey Sol Hadden, Arlington, MA (US); Mustafa Kamal Ahmed, Arlington, MA (US); Jason Lavene, Acton, MA (US)

(73) Assignee: Keurig Green Mountain, Inc., Burlington, MA (US)

(21) Appl. No.: 17/640,447

(22) PCT Filed: Sep. 22, 2020
(86) PCT No.: PCT/US2020/051946

§ 371 Date: Mar. 4, 2022

Related U.S. Application Data
(60) Provisional application No. 62/905,470, filed on Sep. 25, 2019.

(51) Int. Cl. A47J 31/44

(52) U.S. Cl. CPC A47J 31/4492

(57) ABSTRACT

A beverage forming system having a controller arranged to adjust at least one of a set of brew parameters in response to a failure to identify a characteristic of a capsule to be used to form a beverage. An adjusted brew parameter may be a configuration-type parameter that is generally has a fixed value for all or most beverage dispensing operations, or a beverage-specific parameter that may be user-adjusted for each beverage dispensing operation.

### CROSS REFERENCE TO RELATED APPLICATION

This application claims the benefit of U.S. Provisional Application No. 62/905,470, filed Sep. 25, 2019, which is hereby incorporated by reference in its entirety.

### BACKGROUND

### 1. Field of Invention

This invention relates to beverage forming systems, such as coffee brewers that use a liquid to form a coffee beverage.

### 2. Related Art

Beverage forming systems that use a liquid, such as water, to form a beverage are well known. For example, U.S. Patent Application publication 2008/0134902 discloses a beverage forming system that heats water in a reservoir and pneumatically delivers the heated water to a brew chamber for making a coffee drink or other beverage. U.S. Pat. No. 7,398,726 discloses another beverage forming system that delivers heated water from a dispensing tank to a brew chamber by pneumatic forcing of the water from the metering tank. U.S. Patent Application publications 2009/0120299 and 2008/0092746, and U.S. Pat. Nos. 3,511,166, 3,958,502, 4,602,145, 4,263,498 and 8,037,811 disclose other system types in which water in a heater tank or heat exchanger is forced to flow out of the tank and to a beverage making station by introducing unheated water into the tank/exchanger.

### SUMMARY OF INVENTION

In one aspect, a beverage forming system includes a liquid supply arranged to provide a liquid for forming a beverage, a beverage forming station arranged to hold a beverage material for mixing with the liquid to form a beverage, and a liquid conditioner arranged to heat or cool the liquid that is provided to the beverage forming station. A control circuit may be arranged to control the liquid supply and the liquid conditioner to operate automatically according to a set of brew parameters including at least one user-settable brew parameter during a dispensing operation to deliver heated or cooled liquid to the beverage forming station to form the beverage. For example, the system may use parameters related to beverage temperature and volume so that a beverage of a particular temperature and volume is dispensed. Such parameters may be set by a user, e.g., by interacting with a user interface that allows the user to adjust a temperature, volume or other parameter used to form a beverage. Alternately, some or all such parameters may be set by default or in some other automatic way, e.g., by employing parameters associated with a recipe for a particular beverage to be dispensed. In some cases, the control circuit may have a reader adapted to identify at least one characteristic of a capsule held by the beverage forming station, e.g., a RFID tag interrogator, camera, scanner or other reader that can read indicia from capsule. A characteristic read from a capsule may be used to define one or more brew parameters, such as where a parameter is included in a characteristic read from the capsule or where the characteristic is used to identify a set of default parameters for use with the capsule. In response to the control circuit failing to identify a characteristic of the capsule, the control circuit may be adapted to automatically adjust at least one of the set of brew parameters to define an adjusted set of brew parameters, and to form a beverage using the capsule and the adjusted set of brew parameters. This may be done for various reasons, including providing a rapid dispense of hot water, ensuring that a capsule is used to form a beverage at an appropriate temperature or other conditions, help ensuring that a capsule is used to form a beverage with reduced chance of brewing problems, and others. For example, failure of the control circuit to identify a capsule characteristic may indicate that no capsule is present. As a result, the control circuit may set a strength parameter to a “weak” setting by which hot or cooled water is dispensed at a relatively high flow rate. That is, the absence of a capsule may be interpreted as indicating that a user wishes to dispense plain hot or cold water that is not mixed with any beverage ingredient. As a result, a “strength” setting may have no usefulness in such a situation, and a strength setting may be adjusted to a weak or other appropriate setting that causes hot or cold water to be dispensed at a relatively rapid flow rate. Even if a user has previously set or attempts to adjust the strength brew parameter to something different, the control circuit may adjust the strength parameter to the suitable “weak” or other setting that corresponds to a relatively rapid flow rate for dispensing.

As another example, a beverage machine may be arranged to operate with different capsules, including capsules for use in forming cool or chilled beverages as well as hot beverages. Thus, capsules may be adapted for use with a particular water temperature, e.g., capsules intended to be used to make a chilled beverage may be arranged to work with water at temperatures of 120 degrees F. or less. If a control circuit cannot identify a characteristic of a capsule, one or more brew parameters can be adjusted to account for unknown capsule characteristics, such as an inability to withstand high temperatures. In this way, hot water will not be delivered to a capsule intended to make a cool beverage and not constructed to withstand hot water. Thus, a beverage temperature may be adjusted to an appropriate setting, such as 120 degrees F. or less, when a capsule characteristic cannot be identified. As in other cases, a user may not be permitted to change a control circuit-adjusted brew parameter where the adjustment is made based on a failure to identify a capsule characteristic.

Thus, in some cases the control circuit may be adapted to automatically adjust a user-set brew parameter to define the adjusted set of brew parameters. The user-set brew parameter may be any suitable parameter, such as a beverage temperature, a pressure of fluid used to form the beverage, and/or a beverage volume, and may be a parameter that a user can easily set for each beverage cycle or a configuration-type parameter that is user adjustable but not easily done or intended for each beverage forming cycle. In some cases, the set of brew parameters used to form a beverage includes at least one configuration-type brew parameter that has a default value used for all beverage formation operations. For example, some coffee brewers may be configured to make all beverages using water at a particular default temperature, e.g., a control circuit may control a heater to heat water delivered to the brew chamber to a particular temperature for all beverages under normal conditions. A user may be able to adjust the water temperature in such a brewer, but doing so may require employing hidden buttons, unusual button combinations or other more complicated ways to access the temperature adjust feature. Alternately, a user may not be able to adjust a configuration-type parameter at all. However, in some cases, the control circuit may be adapted to adjust a configuration-type brew parameter (such as water temperature, fluid pressure, etc.) in response to the control circuit failing to identify the characteristic of the capsule.

These and other aspects of the invention will be apparent from the following description and claims.

### BRIEF DESCRIPTION OF DRAWINGS

Aspects of the invention are described below with reference to the following drawings in which like numerals reference like elements, and wherein:

FIG. 1 is a perspective view of a beverage machine with user interface located at a beverage forming station in an illustrative embodiment;

FIG. 2 is a schematic view of the beverage forming station in the FIG. 1 embodiment showing a capsule reading system;

FIG. 3 is a view of a user interface including brew parameters for a default set of brew parameters;

FIG. 4 is a view of a user interface including a user-adjustable indication for three brew parameters;

FIG. 5 is a view of the FIG. 4 user interface including an indication for a controller-adjusted brew parameter in response to failure to identify a capsule characteristic;

FIG. 6 is a schematic diagram of a beverage machine connected to a remote computer and/or user device via a network in an illustrative embodiment; and

FIG. 7 is a schematic diagram of components of a beverage machine in an illustrative embodiment.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. For example, aspects of the invention are described with reference to a specific user interface arrangement, but aspects of the invention are not limited to the user interface arrangements described herein. Thus, aspects of the invention are not intended to be construed narrowly in view of the illustrative embodiments. In addition, it should be understood that aspects of the invention may be used alone or in any suitable combination with other aspects of the invention.

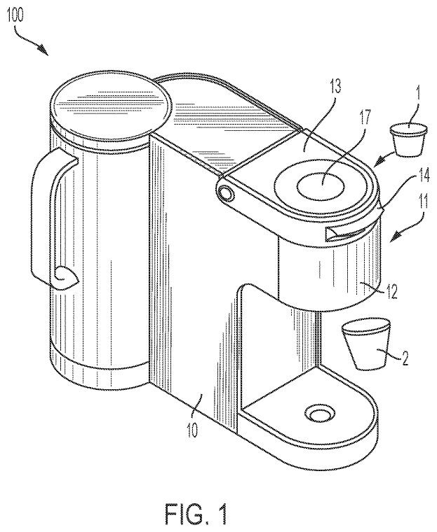

FIG. 1 shows a perspective view of a beverage machine 100 in an illustrative embodiment that incorporates aspects of the invention. For purposes herein, the beverage machine 100 may be used to form any suitable beverage, such as tea, coffee, other infusion-type beverages, carbonated beverages, beverages formed from a liquid or powdered concentrate, soups, juices or other beverages made from dried materials, or others. As will be appreciated, the beverage machine may produce hot and/or cold beverages. In the illustrative embodiment of FIG. 1, the machine 100 is arranged to form coffee or tea beverages (e.g., as a beverage brewer). As is known in the art, a beverage capsule, such as beverage capsule 1, may be provided to the machine 100 and used to form a beverage that is dispensed into a container 2, such as a user's cup, carafe or other. The capsule 1 may be manually or automatically provided to a beverage forming station 11 of the beverage machine 100. For example, the beverage forming station 11 may include a capsule holder 12 that is exposed to receive the capsule 1 when the user (or machine controller) operates a handle or other actuator 14 to open the forming station 11, e.g., by moving a lid or other cover 13 with respect to the capsule holder 12. With the capsule 1 placed in the capsule holder 12, the capsule holder 12 and lid 13 may be moved relative to each other to at least partially enclose the capsule 1, e.g., so that water or other precursor liquid can be introduced into the capsule 1 to form a beverage. For example, with the capsule 1 held in the beverage forming station 11, the capsule 1 may be pierced to form inlet and outlet openings through which water or other precursor liquid enters the capsule 1 and beverage exits the capsule 1, respectively. U.S. Pat. No. 8,361,527 describes a capsule and a system for introducing liquid into the capsule that may be used in an embodiment of this invention, and is hereby incorporated by reference in its entirety.

A user may receive information from, and/or provide information to, the beverage machine 100 via a user interface 17, which may include a display, buttons, switches, touch screen and/or other elements for information display and reception. As described in more detail below, the user interface 17 may be interacted with by a user to adjust one or more brew parameters used by the machine 100 to form a beverage. Such parameters may include a beverage volume, temperature, strength, time period, carbonation level, etc. Adjusting a “strength” of a beverage may be performed in different ways, such as using additional beverage material to form a beverage than a standard amount, using less water to form a beverage than a standard amount, using a higher water or steam pressure to form a beverage than a standard level (e.g., espresso coffee is made using higher pressure water or steam than drip-type coffee), and others. In the illustrative embodiment below, adjusting the “strength” of a beverage is done by adjusting a flow rate of water to the beverage forming station: a slower flow rate provides longer contact time between water and beverage material, thereby increasing a “strength” of the beverage dispensed.

The machine 100 may use a set of one or more brew parameters to form a beverage, and a set of brew parameters may include beverage-specific parameters that are definable for each particular beverage and/or configuration-type parameters that each have a value which is generally used for all or a large number of beverages formed by the machine 100. The beverage-specific parameters and/or configuration type parameters may be adjusted by a user, although if adjustable, may be adjusted in different ways. For example, a user may select or at least have the ability to adjust beverage-specific parameters for each beverage. Examples of this type of parameter include beverage volume and/or strength, although others are possible. In some embodiments, the user interface 17 may have one or more buttons or other features that enable a user to select a desired value for beverage volume, strength, etc. and then instruct the machine 100 to start a beverage formation process, such as by pressing a “brew button” or otherwise providing instruction to start beverage formation. In response, the machine 100 will dispense the beverage using the set of brew parameters.

While a user may have the ability to adjust configuration-type parameters, the process for adjusting such parameters may be different than for beverage-specific parameters, e.g., because configuration-type parameters are generally not intended to be adjustable for each beverage formation process. Examples of this type of parameter are beverage temperature and a pressure of liquid used to form a beverage. (It should be understood, however, that this is not an exhaustive list, and beverage temperature and liquid pressure may be beverage-specific parameters in some implementations. The same is true of beverage volume and strength, which may be configuration-type parameters in some machines 100.) In many coffee brewers, the machine 100 is configured to heat water to a particular beverage temperature for delivery to a beverage forming station, e.g., for mixing with beverage ingredients. (As used herein, a “beverage temperature” refers to a temperature of liquid that is used to form a beverage and/or a temperature of a dispensed beverage. The actual temperature of a dispensed beverage may be the same, or different (e.g., lower) than the temperature of liquid used to form a beverage, e.g., because in some cases ingredients at the beverage forming station may cool the liquid to at least some extent. Thus, it should be understood that “beverage temperature” refers to a target heating or cooling temperature for a water heater or other liquid conditioner that provides liquid for forming a beverage, as well as a target or intended temperature of dispensed beverage.) For example, many coffee brewers are configured to deliver water to a beverage forming station that is at a predefined temperature of around 195 degrees F. Some coffee brewers allow a user to adjust the target heating or beverage temperature, e.g., to compensate for high altitude locations where a brewer is used, and to do so, a user may be instructed to interact with the user interface 17 in a non-standard way. As merely one example, a user may be instructed to simultaneously press two user interface buttons that are not generally pressed at the same time, e.g., an illumination on/off button and a 10 ounce beverage volume button. This may cause the machine 100 to enter a mode in which the user can adjust the beverage temperature. Thus, configuration-type parameters may be adjustable by a user, but not in a standard way and not intended for adjustment for each beverage formation cycle.

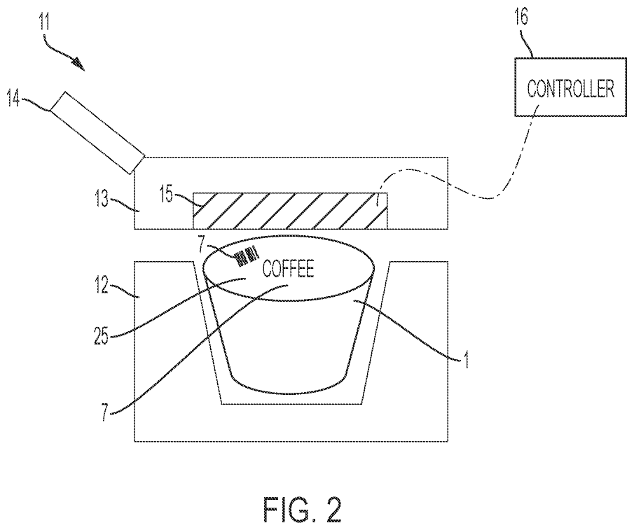

In some cases, a beverage machine 100 may be arranged to define a set of brew parameters that at least initially have default values for each beverage formation process. As an example, each time the machine 100 is employed to make a beverage, values for beverage parameters may be selected and used for forming a beverage unless changed by a user. Often, configuration-type parameters will have a same default value for each beverage formation process, and beverage-specific parameters may as well. Default settings for brew parameters may be retrieved from memory or otherwise determined. In some cases, at least some default settings for brew parameters may be determined by a controller based on at least one characteristic identified from a capsule 1 that is to be used to form a beverage. For example, as shown schematically in FIG. 2, the beverage forming station 11 includes a reading device 15 arranged to capture an image of a portion of the capsule 1 or otherwise identify a characteristic of the capsule 1. In some cases, the capsule may include one or more machine readable indicia 7 such as alphanumeric text, a logo, a barcode (e.g., a 2D or 3D barcode), RFID tag, inductive element, magnetic strip or other element, optically sensed element (e.g., visible or invisible text, graphics, color), physical structures or other indicia arranged to indicate a characteristic of the capsule. Characteristics indicated by indicia 7 on the capsule 1 may include a manufacturer name or location, a brand name or logo, a type of beverage ingredient in the capsule or beverage to be made using the capsule, instructions and/or machine settings for use in preparing a beverage using the capsule, an authentication code or other information that permits the machine 100 to operate using the capsule, etc. Based on a characteristic of the capsule 1 identified by the controller 16, the controller 16 may determine default values for one or more brew parameters, at least some of which may be adjustable by a user before or while a beverage is dispensed.

A reading device 15 used by the controller 16 to identify a characteristic of a capsule 1 may be arranged in different ways. As shown in FIG. 2, an imaging device 15 may be mounted to the lid 13 of the beverage forming station 11 and be arranged to capture an image of a portion of a top or lid 25 of the capsule 1. Of course, other portions of a capsule may be imaged or otherwise read, and the portion that is imaged need not necessarily include indicia 7. An image captured by the imaging device 15 may include one or more indicia 7 on the capsule 1, e.g., an image may include both text and a barcode on the lid 25 of the capsule as shown in FIG. 2. In some embodiments, the imaging device 15 may capture an image of the entire lid 25 of the capsule 1. The imaging device 15 may be arranged to capture two or more images of a portion of the capsule 1, such as by scanning across the lid 25 of the capsule, and the imaging device 15 may include two or more image sensors, such as a camera or other image sensor for visible light, infrared light, ultraviolet light, or other electromagnetic radiation. Multiple sensors may be employed to image an area of the capsule 1, e.g., images captured by multiple sensors may be stitched together to form a single image or otherwise used. Other types of reading devices 15 may be used, such as RFID readers, barcode scanners, etc.

As shown in FIG. 2, the reading device 15 is operatively coupled to a controller 16 which includes control circuitry adapted to control operation of the reading device 15, receive image data from the reading device 15, perform image processing, decoding or other operations on the image data, and/or control other components of the beverage machine 100. In some embodiments, the controller 16 activates the reading device 15 to capture an image of at least a portion of the capsule when the capsule is in the capsule holder 12, e.g., so the controller 16 can determine a set of default settings for brew parameters to be used to form a beverage using the capsule 1. In some embodiments, the reading device 15 captures an image of the capsule as parts of the beverage forming station 11 move relative to each other to at least partially enclose the capsule. For example, an image may be captured when a user interacts with the actuator 14 to move the lid 13 from an open position to a closed position with respect to the capsule holder 12. By capturing an image of the capsule 1 as the capsule 1 is being enclosed at the forming station 11, the controller 16 can ensure that indicia read from the capsule 1 corresponds to the capsule subsequently used to form a beverage, or even allow the controller 16 to detect that no capsule 1 is present in a capsule holder 12. For example, if a capsule 1 is imaged before movement begins at the forming station 11 to enclose the capsule 1, it is possible that a user may replace the imaged capsule 1 with another and then close the forming station 11. In this case, the controller 16 will not have an image of the capsule 1 that was actually used to form the beverage. In contrast, by reading the capsule 1 as the capsule 1 is being enclosed by the forming station 11 (e.g., as the capsule holder 12 and lid 13—or other forming station parts—are being moved relative to each other from an open position to a closed position), the controller 16 can better ensure that the read indicia properly corresponds to the capsule used to subsequently form a beverage. In addition, reading indicia of the capsule as one or more parts of the forming station 11 are moved to enclose a capsule 1 allows the controller 16 to take suitable action, e.g., decoding image data, presenting brew options to a user on the user interface 17, etc., before or shortly after the forming station 11 is closed. This may reduce a wait time that a user may otherwise have to endure if the capsule 1 is read after the capsule is enclosed at the forming station 11. In some embodiments, the controller 16 may include one or more sensors to detect not only movement of forming station 11 parts toward a closed position, but also movement of the forming station 11 parts toward an open position. This can allow the controller 16, for example, to detect that a lid 13 is being moved toward a closed position and trigger the reading device 15 to read indicia of the capsule, and if the controller 16 detects that the lid 13 moves toward an open position (e.g., allowing the capsule 1 to be removed before formation of a beverage), the controller 16 may discard the indicia information. By using only indicia read as a forming station 11 is being moved toward a closed position, the controller 16 can ensure that appropriate indicia is corresponded with a subsequently formed beverage. (While this embodiment refers to imaging indicia 7 on a capsule, any suitable reading of indicia can be employed, such as electronically communicating with an RFID tag or other electronic device, sensing a mechanical code, etc.)

In some cases, a reading device 15 and controller 16 may fail to identify a characteristic of a capsule held by the forming station of the machine 100. This may occur for various reasons, such as there may be no capsule 1 held by the forming station 11, a capsule 1 held by the forming station 11 includes no readable indicia 7 (e.g., a capsule may include no readable text, barcode, etc.), and/or a capsule 1 may have readable indicia 7 such as a barcode, but the reading device 15 may fail to properly read the indicia 7 (e.g., because the indicia 7 is obscured by dirt or other foreign material, is damaged, has a format that the reading device 15 cannot decode, etc.). In such a case, the controller 16 may adjust one or more brew parameters to alter a way that a subsequent beverage is dispensed. Also, in some cases, a brew parameter adjusted by the controller 16 in response to failure to identify a capsule characteristic may not be adjustable by a user. This may be done for various reasons, including providing a rapid dispense of hot water, ensuring that a capsule is used to form a beverage at an appropriate temperature or other conditions, help ensuring that a capsule is used to form a beverage with reduced chance of brewing problems, and others. For example, failure of the controller 16 to identify a capsule characteristic may indicate that no capsule is present in the forming station 11. As a result, the controller 16 may set a strength parameter to a “weak” setting by which the machine 100 dispenses hot or cooled water to the forming station at a relatively high flow rate and without any intermittent or pulsed delivery that might be used for higher strength settings. That is, the absence of a capsule in a beverage forming station may be interpreted as indicating that a user wishes to have the machine 100 dispense plain hot water that is not mixed with any beverage ingredient at the forming station 11. As a result, a “strength” setting may have no usefulness in such a situation, and the controller 16 may adjust a strength setting for the beverage dispensing operation to a weak or other appropriate setting that causes hot water to be dispensed at a relatively rapid flow rate. Even if a user has previously set or attempts to adjust the strength brew parameter to something different (e.g., where strength is a configuration-type parameter), the controller 16 may adjust the strength parameter to the suitable “weak” or other setting that corresponds to a relatively rapid flow rate for dispensing.

As another example, a beverage machine 100 may be arranged to operate with a wide variety of different capsules, including capsules for use in forming cool or chilled beverages as well as hot beverages. Some of these capsules may be adapted for use with a particular water temperature or at least water below a threshold temperature, e.g., capsules intended to be used to make a chilled beverage may be arranged to work with water at temperatures of 120 degrees F. or less. If a controller 16 cannot identify a characteristic of a capsule 1, e.g., indicia 7 on the capsule 1 cannot be properly read, the controller 16 may adjust one or more brew parameters to account for capsule characteristics, such as an inability to withstand high temperatures. Thus, the controller 16 may adjust a beverage temperature to an appropriate setting, such as 120 degrees F. or less, when a capsule 1 characteristic cannot be identified. As noted above, the controller 16 may adjust configuration-type brew parameters (such as beverage temperature) or beverage-specific parameters in response to failure to identify a capsule characteristic, and adjustment by the controller 16 may not be overridden or otherwise changed by a user. For example, a controller 16 may be adapted to adjust a beverage volume to be no more than 12 ounces if a characteristic of a capsule 1 cannot be identified. This may be done to help ensure that a beverage that meets consumer taste requirements is dispensed. For example, a beverage machine 100 may be arranged to dispense beverages up to 24 ounces in volume, but beverages having a volume of 14-24 ounces may only be dispensed when specially configured capsules 1 are used. Otherwise, capsules 1 most commonly used with the machine 100 may be arranged to form a beverage of no more than 12 ounces. If the controller 16 cannot identify a characteristic of a capsule 1, the controller 16 may adjust a beverage volume to be 12 ounces (assuming the capsule is the more commonly used capsule configured for 12 ounce beverages or less), and this brew parameter setting may not be adjustable by a user, at least to a value above 12 ounces.

As another example, a machine 100 may be arranged to form beverages by delivering water to a forming station 11 at different pressures, e.g., relatively high pressure for use with espresso-type capsules and relatively low pressure for drip-type coffee capsules. As will be appreciated, capsules arranged to be used with relatively low pressure water or steam may not be capable of withstanding pressures suitable for forming espresso coffee. If a controller 16 cannot identify a characteristic of a capsule 1, the controller 16 may adjust a fluid pressure brew parameter to be no more than a threshold, such as a pressure that is at or below a level that drip-type coffee capsules can withstand. This way, if a drip-type capsule is in a forming station 11 when a characteristic of the capsule cannot be identified, the capsule will not be exposed to unsuitably high pressures.

In some embodiments, the controller 16 may be arranged to use a default set of brew parameters to form a beverage when a characteristic of a capsule is identified. That is, while a user may be able to adjust one or more of the values for the default set of brew parameters, absent such adjustment, the controller will use the default set to form a beverage using a capsule which has a characteristic identified. A default set of brew parameters may be determined by the controller 16 using a stored set of parameter values (e.g., in a database that corresponds to a type of capsule held by the forming station 11), parameter values obtained from indicia 7 on a capsule 1, parameter values from a user's preference settings, etc., as well as from combinations of such sources. For example, the default set of brew parameters may include a beverage temperature that is obtained from a configuration-type database store of the controller 16 as well as a beverage volume that is obtained from a user's preferences which also may be stored in memory of the controller 16 or elsewhere. If a characteristic of the capsule cannot be identified, one or more of the brew parameters in the default set may be adjusted by the controller 16, e.g., by retrieving one or more brew parameters of an adjusted set of parameters from memory of the controller 16 which are used instead of a corresponding brew parameter in the default set. An adjusted brew parameter determined by the controller 16 may be used instead of a user-set brew parameter, whether a configuration-type parameter or beverage-specific parameter.

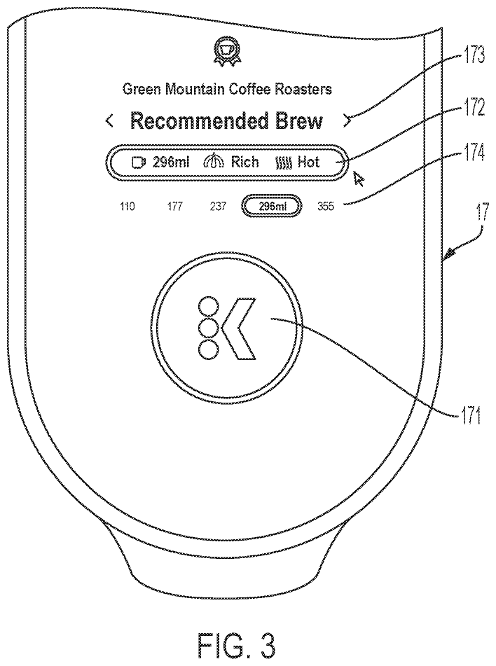

With a capsule 1 received by the forming station 11, the beverage machine 100 can allow a user to instruct the machine 100 to go ahead with forming a beverage using the capsule 1, e.g., using a default set of brew parameters if a characteristic of the capsule is identified or an adjusted set of brew parameters if not. As an example, if a capsule 1 is provided to a forming station 11 and a characteristic of the capsule identified, the controller 16 may cause the user interface 17 to display information like that shown in FIG. 3 to the user. The user interface 17 may include a brew button 171 (e.g., including a circular ring around a stylized “K” logo) on a touch screen that a user can press to cause the controller 16 to begin a brew cycle or other beverage dispensing process. In this embodiment, if the user presses the brew button 171, the controller 16 will cause the machine 100 to operate according to a set of brew parameters that were defined by default and which in this embodiment are summarized in a brew parameter settings menu 172. In this example, three brew parameter settings are summarized in the brew parameter settings menu 172, i.e., beverage volume, strength and temperature, although other brew parameters may be used to form the beverage. While the strength and temperature settings are indicated in a qualitative sense, such settings could be indicated in a quantitative sense, e.g., as a level of total dissolved solids or turbidity for strength, or a temperature or temperature range for beverage temperature.

Sets of brew parameters used by the machine 100 may each have a corresponding name or label, and different sets of brew parameters may be selected by a user. For example, in this embodiment the default set of brew parameters selected by the controller 16 has the name “Recommended Brew” displayed in a parameter set menu 173. As indicated by the arrows “<” and “>” in the parameter set menu 173, a user may scroll left and right in the parameter set menu 173 to select between different sets of brew parameters. In this embodiment, the default set of brew parameters was selected by the controller 16 based on reading indicia 7 on a capsule 1 and based on a characteristic of the capsule 1 (such as a beverage type or name) determined from the indicia 7. For example, the capsule 1 may have indicia 7 that indicates a beverage type “dark roast coffee” and the controller 16 may correlate the beverage type “dark roast coffee” with the brew parameter settings shown in the menu 172 and indicate the corresponding label “Recommended Brew” in the menu 173. Such correlation may be done by referring to a lookup table, database or other information source stored in memory of the controller 16, stored remotely, or stored in indicia 7 of the capsule 1 and read by the controller 16. The user interface 17 may also allow a user to adjust one or more brew parameters using buttons 174, e.g., in this example, multiple buttons 174 are displayed indicating different beverage volumes that can be selected by a user by pressing the touch screen at the desired volume. In this example, the default setting for the beverage volume (“296 ml”) is highlighted by an oval ring displayed around the button 174 for volume “296 ml,” and other volumes can be selected by touching the desired volume number. Other brew parameter options than volume may be displayed so the user can make desired adjustments.

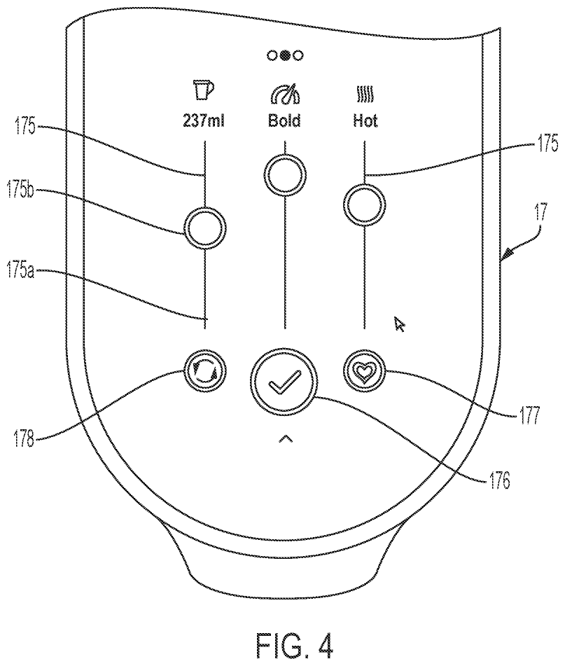

If a user wishes to adjust one or more brew parameters from the default settings for the brew parameters, the user may alternately press the brew parameter settings menu 172. In this example, pressing the brew parameter settings menu 172 may cause the user interface 17 to provide a user-adjustable indication 175 of at least one brew parameter, e.g., for brew parameters of beverage volume, beverage strength and beverage temperature as shown in FIG. 4. Each of the user-adjustable indications 175 provides the controller 16 with the ability to display a current (e.g., default) setting for a brew parameter to a user and to receive a command from the user to adjust the corresponding brew parameter so the controller 16 can use the user-set brew parameter to form the beverage. In this example, each user-adjustable indication 175 includes a slider track 175a extending between maximum and minimum values for the brew parameter and a slider element 175b that is movable along the slider track 175a such that a position of the slider element 175b on the slider track 175a indicates a set value for the brew parameter. For example, if a user moves (by finger touch on the touch screen user interface 17 in FIG. 4) the slider element 175b corresponding to beverage volume (on the far left of FIG. 4) up or down along the slider track 175a, the beverage volume will be correspondingly adjusted up or down. The controller 16 may cause volume-related text and/or an icon (e.g., at the top of the slider track 175a in FIG. 4) to change in correspondence with the adjusted brew parameter setting, e.g., a smaller or larger beverage volume may be displayed along with an icon for a smaller or larger cup to indicate the change in the brew parameter. Other brew parameters may be similarly adjusted for beverage strength and/or temperature and/or other brew parameters. Pressing an “ok” button 176 (indicated by a ring around a check mark in FIG. 4) by the user can cause the controller 16 to accept any changes to the brew parameters, and cause the user interface to revert to a display like that in FIG. 3, although with adjusted brew parameters settings indicated in the brew parameter settings menu 172 and/or along with a corresponding name or label in the parameter set menu 173. Pressing a “favorites” button 177 (indicated by a ring around a heart in FIG. 4) can cause the controller 16 to save the brew parameter settings indicated for later selection and use. The controller 16 may provide the user with an option to save a corresponding name or label for the “favorites” set of brew parameters for selection and/or display in the parameter set menu 173. Pressing a “reset” button 178 (indicated by a ring around a pair of arcuate arrows in FIG. 4) can cause the controller 16 to reset the brew parameters to a default set of brew parameters or other set that was initially indicated on the user interface 17 prior to any user adjustment.

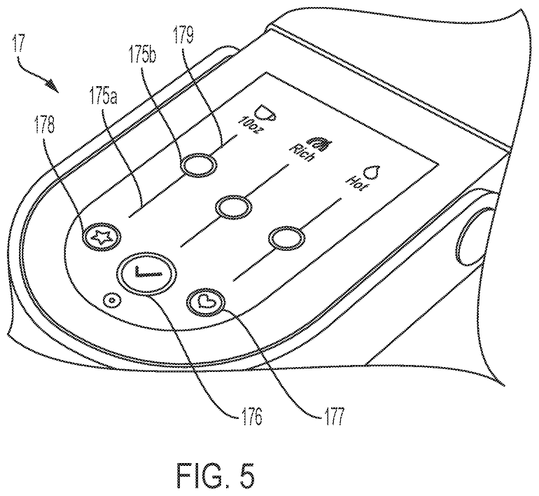

However, if the controller 16 cannot identify a characteristic of a capsule 1, one or more brew parameters may be adjusted by the controller 16 to a value that is different from a default value or a user-set value. For example, if the controller 16 cannot identify a characteristic of a capsule 1, the controller 16 may set a strength brew parameter to a predefined value, e.g., that corresponds to a “weak” setting that maximizes a flow rate of dispensed water. This adjusted setting may be reflected on a display like that in FIG. 3, e.g., indicating the strength setting as “weak.” Also, a label for the adjusted set of brew parameters may be indicated in the brew parameter set menu 173, e.g., as “Capsule Not Identified.” A user may be prevented from selecting other brew parameter sets, e.g., the “>” and “<” buttons of the brew parameter set menu 173 may be inactive or non-responsive to user input. If the user presses the brew parameter settings menu 172 to adjust one or more brew parameters, the user may be permitted to adjust some, but not a controller-adjusted parameter. For example, as shown in FIG. 5, if the controller 16 adjusts the strength setting based on a failure to identify a characteristic of a capsule, the user interface 17 may display user-adjustable indications 175 that allow adjustment for some brew parameters but not the strength parameter. In FIG. 5, a user may be permitted to adjust beverage volume or temperature, but the user-adjustable indication 175 for strength may be modified to disallow adjustment of the strength parameter. In this embodiment, the slider track 175a for strength is shown in dashed line and the slider element 175b is not indicated. This may be intended to convey to a user that strength is not adjustable for this beverage cycle. Of course, other controller-adjusted brew parameters may be treated similarly, e.g., the controller 16 may adjust beverage temperature in response to a failure to identify a capsule characteristic and a user may not be permitted to adjust the temperature parameter. Also, other indications are possible for a controller-adjusted brew parameter, such as the user interface 17 not displaying any option or indication for an adjusted parameter (e.g., the strength-related indicator 175 may not be displayed at all in FIG. 5), text indicating the adjusted brew parameter value may be displayed with a color, text or other indication that the parameter is not adjustable, and others. In other embodiments, a controller 16 may define a maximum or minimum value for an adjusted brew parameter, and allow a user to adjust the parameter provided the user-set value is below the maximum or minimum value. Following the example above, a controller 16 may adjust a strength brew parameter to a relatively low flow rate or “weak” value if a characteristic of a capsule is not identified. A user may be permitted to adjust the strength parameter further, provided that the strength parameter is set by the user to a value that corresponds to “weak” or less, e.g., “very weak.” A similar approach may be used for other parameters, e.g., a beverage temperature may be adjusted by the controller 16 to be 120 degrees F. where a capsule characteristic is not identified. A user may be permitted to further adjust the temperature parameter provided that the temperature is set by the user to a value that is less than 120 degrees F.

Note that while the functionality of the user interface 17 discussed above is implemented on a beverage machine 100, the same or similar functionality may be implemented on another device, such as a user's smartphone, tablet or other device where the other device is arranged to display control information to a user and accept user commands to adjust a brew parameter. As an example, an application operating on a user's smartphone may provide information and receive commands from a user in a same or similar way as that described above so that a user can control operation of a beverage machine 100. Thus, a user may select between multiple stored sets of brew parameters, adjust one or more brew parameters using a slider-type function or other arrangement (including optional limits on brew parameter adjustment), and cause a beverage machine 100 to dispense a beverage using the adjusted parameters via the smartphone or other remote device. The smartphone or other remote device may communicate directly with the controller 16 of the beverage machine 100, e.g., via a local network, or indirectly with the controller 16, e.g., via a remote server or other device and a network such as the Internet.

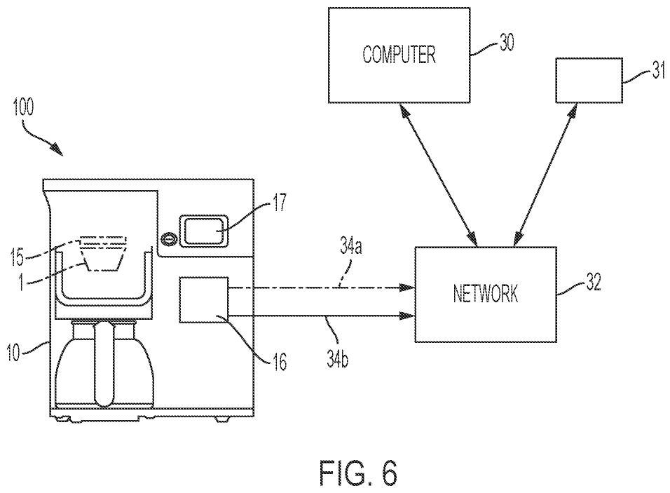

FIG. 6 shows an illustrative arrangement by which a beverage machine 100 may communicate with a remote computer 30 (such as a computer server operated by a manufacturer of the machine 100) and/or a user device 31 (such as a smartphone) via a network 32. In some embodiments, the controller 16, remote computer 30 and/or user device 31 includes a communications interface arranged to receive and send information with respect to the machine 100, such as brew parameter information, operating instructions, messages for display to a user, capsule image data (e.g., undecoded capsule image data), etc. In some embodiments, the beverage machine 100 is configured to read capsule indicia and send beverage preparation parameters to the remote computer 30 and/or user device 31 (e.g., via the controller 16), e.g., capsule indicia 7 data and beverage preparation parameters may be sent before, during or after a beverage is dispensed. Sending such information before dispensing may allow a user and/or remote server to make adjustments or recommendations for adjustments to brew parameters before dispensing. Sending such information during or after dispensing may allow the user and/or remote server to track capsule use, determine when beverage are dispensed and using which brew parameters, etc., and thus may enable the user and/or server to enhance the overall beverage experience. In some embodiments, the beverage preparation parameters recorded and/or sent by the beverage machine include the day of the week, the time of day, the size (e.g., volume) of beverage prepared, the temperature of the water, the strength of beverage formed (e.g., strong, medium, weak), the type of beverage formed, and/or other apparatus settings (e.g., power settings, whether air was introduced into the precursor liquid during beverage formation, a carbonation level of the beverage, a location of the beverage machine during preparation of the beverage or an identity of a user associated with preparation of the beverage). The controller 16 may be configured to decode the capsule indicia 7, e.g., to allow sending of characteristics of a capsule to a user or remote server. As will be appreciated, in such embodiments, the imaging device may include an image decoder (e.g., a barcode reader, optical character recognition software, and/or other image analysis capability). The beverage machine may 100 have one-directional communication with the remote computer 30 and/or user device 31 via the network 32. That is, the machine 100 may communicate with the remote computer 30 and/or user device 31 but may not receive communications therefrom. The remote computer 30 and/or user device 31 may have bi-directional communications ability with the machine 100, and/or other devices connected to the network 30, e.g., the computer 30 may be arranged to send communications directly to a user device 31 (e.g., to a user's telephone or e-mail.). The beverage machine 100 also may be arranged to have bi-directional communication with the remote computer 30 and/or user device 31 (e.g., sending communications to and receiving communications from the remote computer). For example, the remote computer may send information to the machine 100 regarding a message that is displayed on a user interface 17 on the machine 100. In other embodiments, the remote server 30 may send decoded indicia (e.g., a beverage preparation parameter) back to the machine 100, which may then use the parameter to prepare the beverage. The beverage machine 100 may be connected to the network 32 via a wireless connection 34a and/or a wired connection 34b (e.g., via an Ethernet cable).

The remote computer 30 may be configured to track the number of capsules consumed by the user or machine 100 (e.g., the number of capsule used and/or the types of capsules used). In some embodiments, the remote computer may track consumption by tracking capsule and/or brew parameter information that the beverage machine sends to the computer. The remote computer may be configured to determine a user's need for capsule replenishment based on the user's consumption and on past purchase history. In some embodiments, the remote computer determines when a user is in need of capsule replenishment by determining when the user's current supply of capsules falls below a threshold amount (e.g., less than a week's worth of capsules). In some embodiments, the remote computer determines the user's current capsule supply (e.g., a remaining number of unused capsules) by comparing the number of capsules purchased by the consumer (e.g., purchased from the beverage machine manufacturer, such as via an e-commerce website) and the number of capsules consumed by the user. The remote computer also may determine whether the number of remaining capsules has fallen below the threshold amount. The remote computer may run an algorithm to make such a calculation.

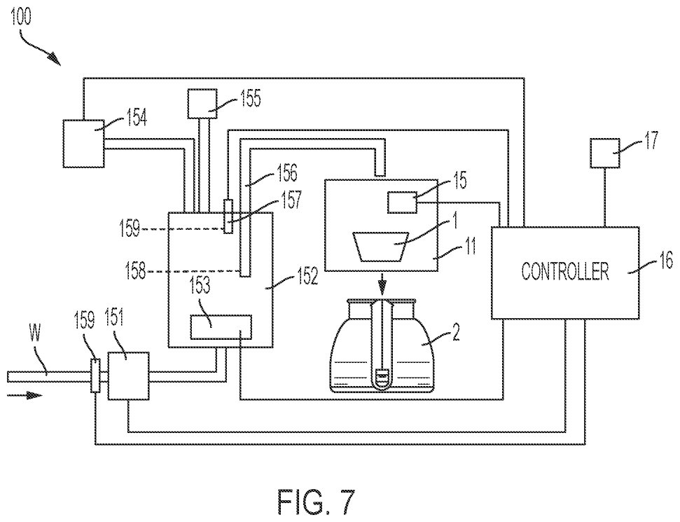

FIG. 7 shows a schematic block diagram of various components that may be included in a beverage machine 100 in one illustrative embodiment. Those of skill in the art will appreciate that a beverage forming apparatus 100 may be configured in a variety of different ways, and thus aspects of the invention should not be narrowly interpreted as relating only to one type of beverage forming apparatus. In this embodiment, water or other precursor liquid may be provided by a liquid supply to mix with a beverage material at a beverage forming station 11. The beverage material (such as coffee grounds, tea leaves, a powdered drink mix, etc.) may be provided in a capsule 1, or not, and beverage produced by mixing the liquid with the beverage material may be dispensed into the container 2 via a beverage outlet.

The liquid supply in this embodiment controls the volume of liquid provided to the beverage forming station 11 by filling a tank to a liquid dispense level 159 and then pressurizing the tank 152 by way of an air pump 154 so that liquid in the tank 152 is forced out of the conduit 156 to the beverage forming station 11. The volume of liquid delivered to the beverage forming station 11 is equal to the volume in the tank 152 between the liquid delivery level 159 and a post-delivery level 158 at a bottom of the conduit 156 in the tank 152. Since there is one delivery level 159 in this embodiment, one volume can be provided to the beverage forming station 11. However, two or more delivery levels may be used.

In this embodiment, the liquid supply provides liquid to the tank 152 via a valve 151 that is coupled to a source W. The source W may have any suitable arrangement, e.g., may provide liquid from a removable or fixed storage tank, a mains water supply or other source. Thus, in some cases, the liquid provided to the tank 152 may vary in temperature by a wide degree depending on various factors, such as time of year, a temperature of a room in which the machine 100 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

To provide liquid to the tank 152 in this embodiment, the valve 151 is controlled by the control circuit 16 to open and close to provide a desired volume of liquid to the tank 152. For example, if the tank 152 is empty or at the post-dispense level 158, the valve 151 may be opened until a conductive probe or other liquid level sensor 157 provides a signal to the control circuit 16 that indicates when liquid arrives at the dispense level 159. In response to the level sensor 157 detecting liquid at the sensor 157, the control circuit 16 may close the valve 151. Of course, other arrangements are possible, such using a pump to move liquid from a storage reservoir to the tank 152.

Although in this embodiment the liquid level sensor includes a conductive probe capable of contacting liquid in the tank 152 and providing a signal (e.g., a resistance change) indicative of liquid being present at respective dispense level 159 in the tank 152, the liquid level sensor may be arranged in other ways. For example, the sensor may include a microswitch with an attached float that rises with liquid level in the tank 152 to activate the switch. In another embodiment, the liquid level sensor may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level sensor is not necessarily limited to a conductive probe configuration. Moreover, the liquid level sensor may include two or more different types sensors to detect different levels in the tank. For example, a pressure sensor may be used to detect liquid at a dispense level (e.g., complete filling of the tank 152 may coincide with a sharp rise in pressure in the tank 152), while a conductive probe may be used to detect liquid at the other dispense level 159.

Further, a liquid level sensor need not be used to fill the tank to the dispense level 159. Instead, other techniques may be used to suitably fill the tank 152, such as opening the valve 151 for a defined period of time that is found to correspond to approximate filling of the tank 152 to the desired level. Of course, other arrangements for providing liquid to the tank 152 are possible, such as by a pump (e.g., a centrifugal pump, piston pump, solenoid pump, diaphragm pump, etc.), gravity feed, or other, and the way by which the tank is filled to the dispense level 159 may depend on the technique used to provide liquid to the tank. For example, control of a volume of liquid provided to fill the tank 152 to the dispense level 159 may be performed by running a pump for a predetermined time, detecting a flow rate or volume of liquid entering the tank 152 (e.g., using a flow meter), operating a pump for a desired number of cycles (such as where the pump is arranged to deliver a known volume of liquid for each cycle), detecting a pressure rise in the tank 152 using a pressure sensor, or using any other viable technique.

Liquid in the tank 152 may be heated by way of a heating element 153 whose operation is controlled by the control circuit 16 using input from a temperature sensor or other suitable input. Also, the tank 152 may be arranged as an inline or continuous flow heater that has a relatively small volume, e.g., a tube with associated heating element to heat liquid in the tube. Of course, heating of the liquid is not necessary, and instead (or additionally) the apparatus 100 may include a chiller to cool the liquid, a carbonator to carbonate the liquid, or otherwise condition the liquid in a way that alters the volume of liquid in the tank 152. (Generally speaking, components of the liquid supply that heat, cool, carbonate or otherwise condition liquid supplied to the beverage forming station 11 are referred to as a “liquid conditioner.”)

In this embodiment, liquid may be discharged from the tank 152 by an air pump 154 operating to force air into the tank 152 to pressurize the tank and force liquid to flow in the conduit 156 to the beverage forming station 11. Since the conduit extends downwardly into the tank 152, the volume of liquid delivered to the forming station 11 is defined as the volume in the tank 152 between the dispense level 159 and the bottom end of the conduit 156. Again, liquid may be caused to flow from the tank 152 to the beverage forming station 11 in other ways. For example, a pump may be used to pump liquid from the tank 152 to the forming station 11, a pump could force liquid into the tank 152 which causes liquid in the tank to move to the forming station 11, liquid may be allowed to flow by gravity from the tank 152, and others. A volume of liquid delivered from the tank to the forming station 11 may be controlled based on a volume of liquid forced into the tank 152, which may be detected by a flow meter, pump cycles, etc. A vent 155, which can be opened or closed to vent the tank 152, may be provided to allow the tank 152 to be filled without causing a substantial rise in pressure in the tank 152 and to allow liquid to be delivered from the tank 152 by pressurizing the tank using the air pump 154. In this embodiment, the vent 155 is actually not controlled by the control circuit 16, but remains always open with an orifice of suitable size to allow venting for filling of the tank 152, and air pressure buildup in the tank 152 to allow liquid delivery. Other flow control features may be provided as well, such as a check valve or other flow controller that can prevent backflow in the conduit between the source W and the tank 152, or between the tank 152 and the beverage forming station 11.

The beverage forming station 11 may use any beverage making ingredient, such as ground coffee, tea, a flavored drink mix, or other beverage medium, e.g., contained in a capsule 1 or not. Alternately, the beverage forming station 11 may function simply as an outlet for heated, cooled or otherwise conditioned water or other liquid, e.g., where a beverage medium is contained in the container 2. Once liquid delivery from the tank 156 to the station 11 is complete, the air pump 154 (or other air pump) may be operated to force air into the conduit 156 to purge liquid from the beverage forming station 11, at least to some extent.

Operation of the valve 151, air pump 154 and other components of the apparatus 100 may be controlled by the control circuit 16, e.g., which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. As discussed above, the user interface 17 may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A beverage forming system comprising:
a liquid supply arranged to provide a liquid for forming a beverage;
a beverage forming station arranged to hold a beverage material for mixing with the liquid to form a beverage;
a liquid conditioner arranged to heat or cool the liquid that is provided to the beverage forming station; and
a control circuit arranged to control the liquid supply and the liquid conditioner to operate automatically according to a set of brew parameters including at least one user-settable brew parameter during a dispensing operation to deliver heated or cooled liquid to the beverage forming station to form the beverage, the control circuit having a reader adapted to identify at least one characteristic of a capsule held by the beverage forming station, the control circuit adapted to automatically adjust at least one of the set of brew parameters to define an adjusted set of brew parameters in response to the control circuit failing to identify a characteristic of the capsule, and to form a beverage using the capsule and the adjusted set of brew parameters.

2. The beverage forming system of claim 1, wherein the control circuit is adapted to automatically adjust a user-set brew parameter to define the adjusted set of brew parameters.

3. The beverage forming system of claim 2, wherein the user-set brew parameter includes a beverage temperature, a pressure of fluid used to form the beverage, or a beverage volume.

4. The beverage forming system of claim 1, wherein the set of brew parameters includes at least one configuration-type brew parameter that has a default value used for all beverage formation operations.

5. The beverage forming system of claim 4, wherein the control circuit is adapted to adjust the at least one configuration-type brew parameter in response to the control circuit failing to identify the characteristic of the capsule.

6. The beverage forming system of claim 5, wherein the at least one configuration-type brew parameter includes a beverage temperature or pressure of fluid used to form the beverage.

7. The beverage forming system of claim 6, wherein the liquid conditioner includes a heater to heat water that is provided to the beverage forming station, and the control circuit is adapted to adjust the beverage temperature which is used to control the operation of the heater.

8. The beverage forming system of claim 7, wherein the beverage temperature is a user-adjustable configuration-type brew parameter.

9. The beverage forming system of claim 4, wherein the set of brew parameters includes one or more brew parameters that are user-adjustable for each beverage formation operation.

10. The beverage forming system of claim 9, wherein the control circuit is adapted to adjust at least one of the brew parameters that are user-adjustable for each beverage formation operation in response to the control circuit failing to identify the characteristic of the capsule.

11. The beverage forming system of claim 10, wherein the control circuit includes a user interface via which a user can interact to adjust at least one of the brew parameters.

12. The beverage forming system of claim 5, wherein the at least one configuration-type brew parameter is not user adjustable.

13. The beverage forming system of claim 1, wherein the at least one characteristic of the capsule includes a company logo or alphanumeric text.

14. The beverage forming system of claim 1, wherein the set of brew parameters is a default set of brew parameters in which each brew parameter has a default value and the default set of brew parameters is used by the controller to form a beverage when at least one characteristic of a capsule is identified by the controller.

15. The beverage forming system of claim 14, wherein at least one of the default set of brew parameters is adjustable by a user when the at least one characteristic of the capsule is identified by the controller.
